(19) United States
(12) Patent Application Publication
(10) Pub. No.: US 2004/0240408 A1
(43) Pub. Date: Dec. 2, 2004

(54) System, method and apparatus for the generation and deployment of mobile applications

(75) Inventor: Nadav Gur, Rechovot (IL)

Correspondence Address: HOGAN & HARTSON LLP, IP GROUP, COLUMBIA SQUARE, 555 THIRTEENTH STREET, N.W., WASHINGTON, DC, 20004, US

(73) Assignee: MOBIMATE LTD., Rechovot (IL)

(21) Appl. No.: 10/449,696

(22) Filed: Jun. 2, 2003

(51) Int. Cl. H04Q 7/00

(52) U.S. Cl. 370/328

(57) ABSTRACT

A system, apparatus, and method for the development and deployment of applications suitable for mobile devices are disclosed. The applications are dynamically generated by an application engine utilizing unique control information stored in a mobile application descriptor. The application engine receives the descriptor from a server device and in accordance with the information therein dynamically generates a set of dynamic mobile application base components. The application engine enables requests for application data, reception of application data. The application allows the user of the mobile device to execute the dynamic mobile application.

### BACKGROUND OF THE INVENTION

1. Field of the Invention

The present invention relates generally to application development for mobile and hand held communication devices. More particularly, the present invention relates to the dynamic generation and the deployment of a unique mobile application via the utilization of an application engine in conjunction with a mobile application descriptor file.

2. Discussion of the Related Art

The proliferation of portable computing devices has brought mobile devices into wide use. Most professionals and many private individuals now have a mobile device. Cell-phones, two-way pagers, Personal Digital Assistants (PDAs) and now even PDA watches are, in fact, sophisticated computing machinery that is carried around by billions of people worldwide. Furthermore, as most of these devices are networked—whether via wireless cellular or other networks, or via connection to a wired PC or other means, the possibility to connect such devices to a server system and use such devices to deliver and gather information has spurred on a new set of information technologies and a new market. This phenomenon has brought about the creation of a new paradigm called “mobile computing” whereby users access information services using these devices and through the shared infrastructure. See Client/Server Computing in Mobile Environments, Jing, Helal, Elmagarmid, ACM Computing Surveys, 6/95, Vol. 31 Issue 2. The value in mobile information systems, and the perceived need of those, has caused firms and individuals to begin developing such systems and integrating these systems with ‘back-end’ or server systems. In many cases, the back-end system is in fact an existing (“legacy”) system, and the role of the new information system is to deliver data from or to the legacy system. Naturally enough, the initial approaches tried by these new systems' developers are simply extensions of existing models used to develop networked information systems. As the common mobile device is generally analogous to a personal computer, in that it has its own computing and user interaction facilities, such systems fall under the definition of Client/Server systems, where there are one or more clients and one or more servers that form a composite system allowing distributed computation, analysis and presentation. Under the Client/Server paradigm, the mobile device is usually a client, characterized by displaying and managing the user interface, forming queries or commands that are sent to the server via communications, and analyzing and displaying the server's responses. End-users of the system, inasmuch as humans are involved in the system, are usually served by the client systems. Client systems are really application software that executes locally on the user's PC or workstation and does some of the computing tasks required. Traditionally, Client/Server Systems have been generally classified as having either a ‘Thin Client’ or a ‘Fat Client’. This categorization, originally introduced by the Gartner Group in its now-famous reference designs for client-server systems, defines an application in terms of presentation, application and data-access logic. The ‘thinner’ the clients, the less components of the application are handled on the clients' terminal, with most ‘thin’ clients handling only presentation. One of the most common approaches to thin-client computing is the browser approach, where a web-browser application is used to render and manage the application presentation layer. See Web Based Development of Complex Information Products, Fielding R., Whitehead E et al., Communications of the ACM Vol. 41 Iss. 8 Aug. '98. On the other hand, ‘Thick’ or ‘Fat’ clients are characterized by handling more of the application and/or data-access logic on the client terminal, possibly including local database management and local data access. With the advent of the world-wide-web, a new approach was conceived. Under this approach the web browser, locally installed on most personal computers, was to be used as a general-purpose ‘thin client’. Under this approach, most computing requirements would be delegated back to the web application running on an ‘application server’. “Web Application” shall mean web-based applications on the Internet, Intranets and Extranets. A Web Application is characterized by having a system that is in fact a web site in the sense that it is managed on a web-server or using an equivalent architecture, and a Thin-client, which executes in a browser. While successful in relation to computing devices having steady connection to a network, the client/server approach has proven unsatisfactory in the context of mobile devices. One drawback stems from the fact that mobile devices network connection is intermittent and has limited bandwidth. Under the client/server approach clients rely on a steady connection to the server. Such clients present information provided by the server. If the information from the server is not available then the client cannot present information and is therefore rendered useless. Intermittent connection and low bandwidth rendered the mobile device client useless or inefficient. Another drawback is the lengthy time required for mobile devices clients to connect to the network, authenticate, and receive information. Simple queries from the client can take up to 20 seconds to process resulting once again in a useless device, which leads to user dissatisfaction. An additional drawback of the client/server methodology for mobile devices operation is the difficulties in developing software for mobile devices. Mobile devices have only limited processing power and many I/O constraints. These constraints mean that additional cost and man-hours are required to implement web/server networking in the mobile environment.

There is therefore a need for a new and novel mobile methodology to include a system, apparatus, and method that overcome the drawbacks of the prior art.

### SUMMARY OF THE PRESENT INVENTION

One aspect of the present invention regards an apparatus for the generation and deployment of a mobile application associated with a mobile device. The apparatus comprises the elements of an application descriptor to store an application base component definition downloadable from a server device to the mobile device, an application base component in the mobile device to control the execution of the mobile application, and an application engine in the mobile device to obtain the application descriptor, to generate the application base component, to obtain application data, to provide access to application data, to manage communications, to manage data synchronization, and to manage the execution of a mobile application. The apparatus further comprises a communications interface device in the mobile device for establishing communication channels between the mobile device and the server device for downloading the application descriptor from the server device to the mobile device. The application descriptor of the apparatus comprises the elements of an initialization handler to initialize the execution of an application logic script, a user interface definition to hold a parameter that defines the structure of a user interface base component, and a data access definition to hold a parameter that defines the structure of a data access definition base component. The application base component of the apparatus is a data access definition base component. Alternatively, the application base component of the apparatus is an application logic base component. Alternatively, the at least one application base component is a user interface base component. The application engine of the apparatus comprises the elements of a presentation manager to process, format and display application data, a script manager to manage the execution of the at least one application logic base component, a data access manager to manage access to application data, and a computation manager to manage computations associated with the at least one application logic base component. The apparatus further comprises a plug-in manager to manage the execution of a external plug-in module. The apparatus further comprises an alerts manager to manage alerts logic. The apparatus further comprises a wireless communications manager to manage wireless communications between the mobile device and the server device. The apparatus further comprises a synchronization manager to manage data synchronization between the mobile device and the server device. The apparatus further comprises a version manager to provide for application base component version management. The apparatus further comprises an authentication manager to provide user authentication. The apparatus further comprises an XML parser to parse the application descriptor file and the application logic base component. The apparatus further comprises a user manager to manage user access for the user of the mobile device. The apparatus further comprises a usage tracker to collect usage statistics. The apparatus further comprises external plug-ins to provide for the installation, execution and usage tracking of external plug-in routines. The server device is a computing platform having computing and communication capabilities. The mobile device and the server device communicate in a wireless manner via a data communications network. The data communications network is a Local Area Network (LAN). Alternatively, the data communications network is a Wide Area Network (WAN). Alternatively, the data communications network is a cellular telephone communication network. The mobile device communicates with the server device via a desktop device. The desktop device is a computer device such as a personal computer (PC) having computing, communications and data synchronization capabilities. The apparatus further comprises a legacy system to collect and transfer application data to the mobile device in response to application data requests submitted by a user of the mobile device. The legacy system is implemented on a independently operating computing and communicating platform.

A second aspect of the present invention regards a method for the generation and deployment of mobile application associated with a mobile device. The method comprises the steps of transferring an application descriptor file from a server device to a mobile device, generating an application base component in accordance with the associated parameters in the application descriptor file, and generating a dynamic mobile application based on a application engine and the application base component. The method further comprises activating the application engine installed in a mobile device. The method further comprises establishing a communication path between the mobile device and a server device. The method further comprises comparing the application descriptor file in the server device and the application descriptor file in the mobile device. The method further comprises the step of submitting requests for application data to the server device. The method further comprises receiving application data transmitted from the server device in the mobile device. The method comprises sending the results of the user interactions on the application data to the server device.

### BRIEF DESCRIPTION OF THE DRAWINGS

The present invention will be understood and appreciated more fully from the following detailed description taken in conjunction with the drawings in which:

FIG. 1 is a simplified schematic diagram of an existing computerized and mobile network in which a preferred embodiment of the present invention may be operative; and

FIG. 2 is a simplified block diagram describing the system flow, in accordance with a preferred embodiment of the present invention;

FIG. 3 is a simplified block diagram illustrating the architecture of a mobile device, in accordance with a preferred embodiment of the present invention;

FIG. 4 is a simplified block diagram illustrating the architecture of a desktop device, in accordance with a preferred embodiment of the present invention;

FIG. 5 is a simplified block diagram illustrating the architecture of a server device, in accordance with a preferred embodiment of the present invention;

FIG. 6 is an illustrative block diagram describing the components of the mobile application descriptor file, in accordance with a preferred embodiment of the present invention;

FIG. 7 is an illustrative block diagram describing the components of the mobile application, in accordance with a preferred embodiment of the present invention;

FIG. 8 is an illustrative block diagram describing the components of the synchronization module, in accordance with a preferred embodiment of the present invention;

FIG. 9 is an illustrative flow chart that describes the generation and the deployment of a dynamic mobile application, in accordance with a preferred embodiment of the present invention; and

FIG. 10 is an illustrative flowchart that describes the operation of the dynamic mobile application, in accordance with a preferred embodiment of the present invention.

### DETAILED DESCRIPTION OF THE PREFERRED EMBODIMENT

A new and novel system, apparatus, and method that provide for the development and deployment of applications suitable for mobile devices are disclosed. The mobile applications are dynamically generated in a mobile device by a meta client engine generally referred to herein under as the application engine. The application engine utilizes specific control data incorporated in a data structure, generally referred to herein under as the mobile application descriptor. The mobile application descriptor comprises information indicative of the client's user interface, application database structures, and application logic instructions. The application engine in the mobile device receives the mobile application descriptor from a server device and in accordance with the information embedded therein dynamically generates a set of dynamic mobile application base components. These base components include application database structure definitions, user interface definitions, application logic modules, and the like. The application engine further provides the option for the user to submit requests for application data, to obtain the desired application data, and to insert the received application data into an application database built in accordance with the application database structure definitions in the mobile application descriptor. The application engine further provides the option for a user of the mobile device to execute the dynamic mobile application. The user interacts with the dynamic mobile application via the application engine and the set of dynamic application base components in order to browse the information in the database, to perform various calculations based on the information, and generally to interact with the application data. The application engine operates in accordance with the restraints set in the mobile application descriptor and operates as an adjustable, updateable, and upgradeable meta client without the necessity to re-program and re-install the client each time a change to the client's user interface, application database structure or application logic is required. In addition the client is not wholly dependant on network connection. The client includes functions embedded in the application logic and database structures which are able to interact with the user on the local client level without requiring network connection. Results of actions performed by the user may be saved and later transmitted to a server device. Consequent to the transfer of the mobile application descriptor from the server device to the client, the server may provide suitable data to the client to fit in the database structures defined in the descriptor. Data as well as descriptor information may be synchronized directly through a network or indirectly via non-mobile computing device such as a desktop device.

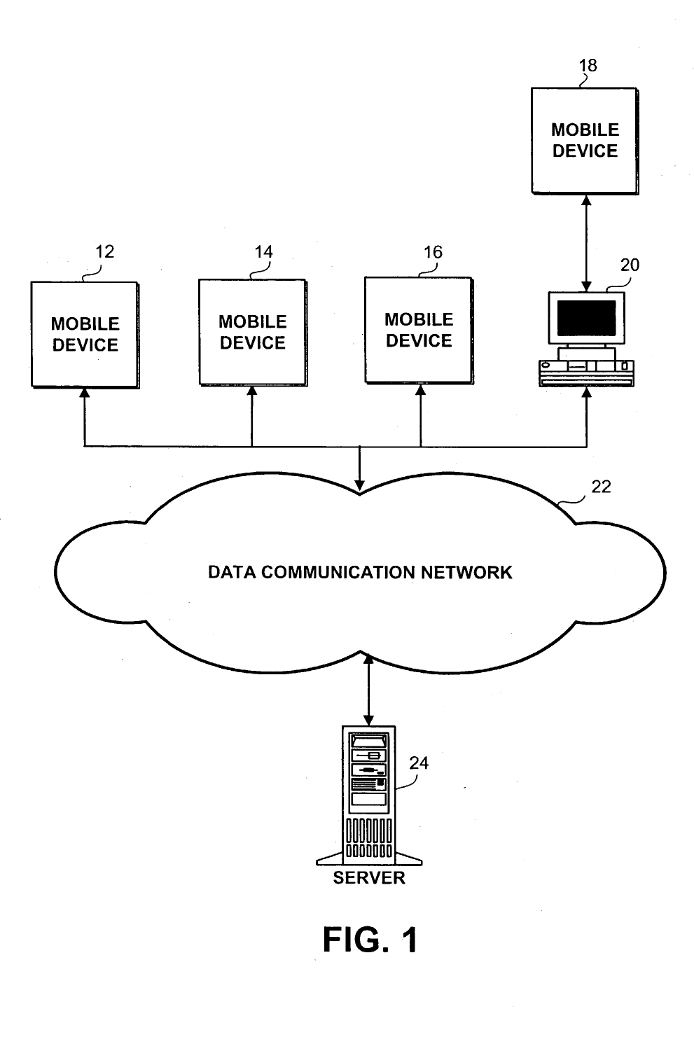

FIG. 1 illustrates a simplified schematic diagram illustrating an existing computerized and mobile network in which the present invention may be operative, in accordance with a preferred embodiment of the present invention. One or more mobile devices 12, 14, 16, 18 are connected directly or indirectly to a server device 24 via data communications network 22. Mobile devices 12, 14, 16, 18 may be hand held device such as personal data assistants (PDA) or mobile phones having computing capabilities, or PDAs having the ability to provide mobile phone services. Commercially available mobile messaging devices include the Nokia 7600 and 9200 series manufactured by Nokia Corporation (ADR), the Sony-Ericsson T68 and P800 manufactured by Sony Ericsson Mobile Communications AB, the HP iPAQ series provided by Hewlett Packard Inc., the Handspring Treo series manufactured by Handspring Inc., the Palm Tungsten series by Palm Inc. and the like. Network 22 could be a conventional data network such as the Internet or any other data faring capable network. Such can include a telephony network, a wireless network, a satellite network a cable network such as a cable television network and the like. The connection to data communication network 22 may be accomplished directly via a wireless network or via direct cable communication. In one preferred embodiment of the present invention the mobile device is connected to data communications network 22 via a computerized device 20, such as a personal computer, and via a communication link. Data may be transferred from server 24 to computing device 18 through a dedicated program downloading the requested information via data communications network 22. The user of mobile device 18 may request to download information from server 24 via computerized device 20 by engaging a process of download. During this process a client computer program (not shown) in mobile device 18 will establish a link with a computer program (not shown) on computing device 20 and request the information desired. The computing device 20 will in turn establish communication with the server 24 in order to download or upload the appropriate information as per the request made. The information communicated from the server 24 to the mobile devices 12, 14, 16, 18 includes mobile application-specific information to be utilized for the dynamic generation and deployment of mobile applications. The information requested by the mobile devices 12, 14, 16, 18 and communicated in response from the server 24 to the mobile devices 12, 14, 16, 18 further includes specific portions of application data to be processed by the dynamic mobile applications in order to provide information to the users of the mobile devices 12, 14, 16, 18.

Alternatively the mobile application-specific information for the dynamic generation and deployment of mobile applications and the application data could be provided from separate information sources, such as server devices dedicated to the provision of mobile application-specific information and/or independently operating computing platforms hosting legacy systems.

One example of this process is known as the process of synchronization further detailed in U.S. Pat. No. 6,330,618. The process of synchronization or like indirect download or upload of requests and information from and to mobile device 18 as well as the direct link between mobile devices 12, 14, 16 and network 22 allows the mobile device to communicate with server 24. Present networks however suffer from inefficiency.

Although on the drawing under discussion only a limited number of mobile devices and a single server device appear it would be readily understood that in a realistic environment a plurality of mobile devices could be communicating to a plurality of server devices, submit substantially simultaneously a plurality of requests, sending a plurality of messages, and perform a plurality of transactions. Although on the drawing under discussion only a single data communications network is shown it would be easily perceived that in a realistic environment the mobile devices 12, 14, 16, 18 could access several inter-connected networks via appropriate gateway devices.

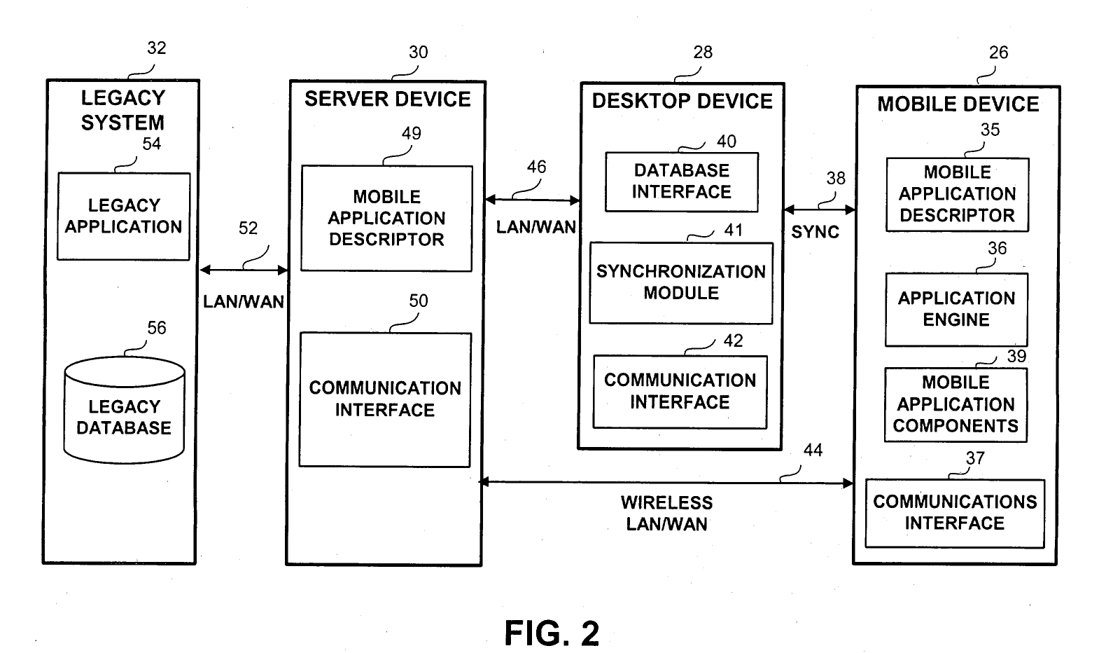

Referring now to FIG. 2 in the preferred embodiment of the invention, the proposed system and method utilizes several computing devices and can operate on a cross platform basis. The participating devices are intermittently or semi-permanently inter-connected in order to allow for the exchange of requests for data and resulting data transmission through appropriate communication procedures implemented via a communication medium, such as a standard IP network infrastructure. The network infrastructure comprises several segments, such as wired segments and wireless segments. Legacy system 32 is a back-end system indirectly supporting front-end services, such as specific services performed in response to requests submitted by clients operating mobile devices. Legacy system 32 is typically driven by a database. Legacy system 32 could include one or more applications inherited from languages, platforms, and techniques earlier than the current technology. Most enterprises that use computers have legacy applications and databases that serve critical business needs. In the preferred embodiment of the invention, legacy system 32 is installed and running on one or more computing platforms. The system 32 is operative in the collection and supply of specific information for mobile device 26. Server device 30 is a computing and communicating platform installed in the network. Server device 30 includes middleware components that provide for direct interaction with the legacy system 32 on the one side and the mobile device 26 on the other side. Mobile device 26 is a computing and communicating device, such as mobile device 12, 14, 16, 18, depicted in association with FIG. 1. Device 26 is connectable to a communications media, such as a local area network (LAN), a metropolitan area network (MAN), a wide area network (WAN) or any other data communication network. Desktop device 28 is a local desktop computer having communication capabilities. Desktop device 28 is connectable on one side to a communications network, such as a LAN, a WAN or other data networks and connected on the other side to mobile device 26 via a wired or wireless connection. Note should be taken that in the proposed system all the connections between each and every component could be accomplished either a wired communication link or alternatively a wireless communication link. Device 26 may communicate with legacy system 32 via communication link 38, via desktop device 28, via a communication link 46, via server device 30, and via communication link 52. Alternatively, mobile device 26 could be communicating with legacy system 32 through communication link 44, through server device 30 and through communication link 52. The communication link from mobile device 26, through desktop device 28, and through server device 30 to legacy system 32 is established in order to enable a user of mobile device 26 to request, to obtain and to interact with specific information associated with legacy system 32. The user of mobile device 26 initiates a communication session with the server device 30 in order to submit requests for legacy data to the server device 30 either directly via communication link 44, or indirectly via local communication link 38, desktop device 28, and communication link 52. The server device 30 responds to the requests submitted by obtaining the requested information from legacy system 32 and by forwarding the information to mobile device 26 either directly via communication link 44 or via communication link 46, desktop device 28, and communication link 38. The communication between desktop device 28 and mobile device 26 via communication link 38 is accomplished by suitable synchronization handlers installed both in desktop device 28 and mobile device 26. Mobile device 26 includes a mobile application descriptor 35, an application engine 36, a set of dynamic mobile application base components 39, and a communication interface 37. Desktop device 28 includes a database interface 40, a synchronization module 41, and a communication interface 42. Server device 30 includes a mobile application descriptor 49, and communication interface 50. Legacy system 32 includes a legacy application 54 and a legacy database 56. Note should be taken that in other preferred embodiments of the invention the legacy system 32 and the server device 30 could operate independently of each other. The mobile application descriptor 49 could be installed either on the legacy system 32 or on the server device 30. The mobile application descriptor 49 may also be installed and operate from a web server remote to the server device 30. The principal functionality of the synchronization module 41 is data synchronization.

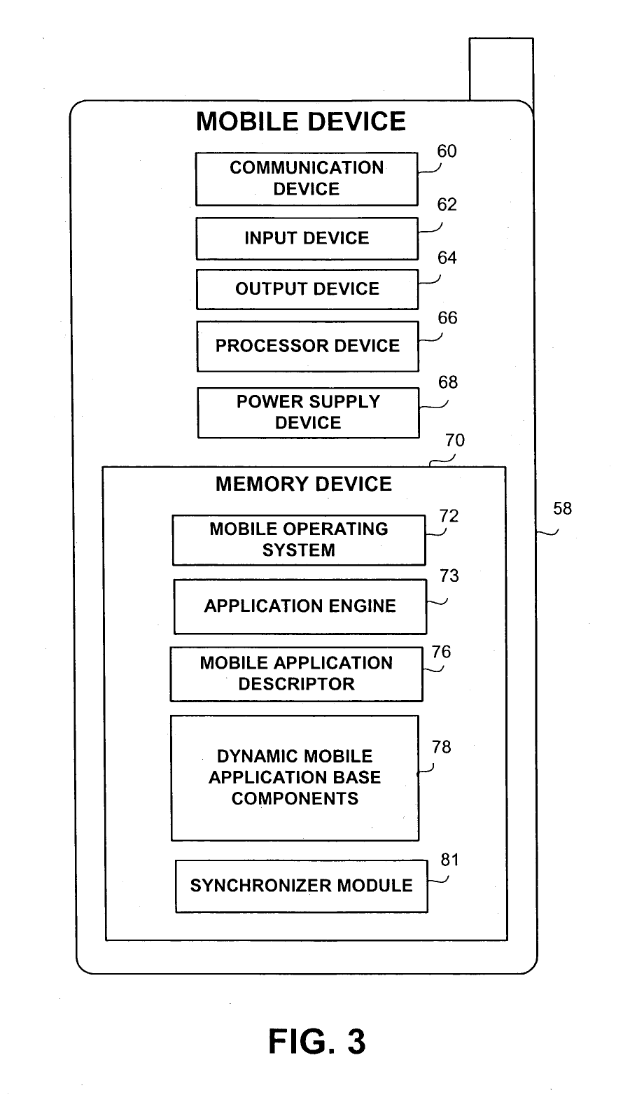

Referring now to FIG. 3 mobile device 58 includes a communication device 60, an input device 62, an output device 64, a processor device 66, a power supply device 68, and a memory device 70. Communication device 60 is preferably a wireless modem operative in the establishment of a wireless link between the mobile device 58 and remote platforms located in the data communication network. The communication device 60 could be any standard modem incorporated within the mobile device 58 or alternatively a communication port for receiving and sending information to a personal computer through which data is sent and received in a data network. Input device 62 is utilized for providing interactive communication between the device 58 and a user. Input device 62 could include a touch-sensitive screen in association with a pen-like stylus, a miniature keyboard, functional buttons, switches, and the like. Input device 62 could further include a handwriting input area and a handwriting recognition module. The output device 64 is typically a display screen to provide for the formatted display of information for the user. The processor device 66 is a logic circuitry that responds to and processes the basic instructions that drive a computing device. The processor device 66 is typically a microprocessor, which is often embedded in small computing devices. Power supply device 68 is utilized to provide power for the operation of mobile device 58. Device 68 is preferably a rechargeable battery device, such as a lithium or nickel-cadmium batteries. Memory device 70 is an electronic holding place for the instructions and data to be read from and write into by the processor device 66.

Still referring to FIG. 3 memory device 70 stores a mobile operating system 72, a mobile application descriptor 76, an application engine 73, a set of dynamic mobile application base components 78, and a synchronization module 81. The mobile operating system 72 is operative in the organization and control of the operations within the mobile device 58. Mobile operating system 72 could the Palm OS, the PocketPC operating systems, and the like. The application engine 73 comprises a user interface rendering capabilities in order to display information and forms on a display device.

Some markup language enable dynamic options, which allow for the display of animated and more user oriented functions. Such can include for example the changing of text displayed when the user points to such text. One exemplary markup language having additional capabilities is the Extensible Markup Language (XML), which provides an extended markup language enabling the creation of new elements, which also describe the information, presented. The mobile application descriptor 76 may be a specifically configured XML-based data structure that is operative in conjunction with the application engine 73 in the dynamic generation and deployment of a unique mobile client application via the creation of the dynamic mobile application base components 78. Other like configurations may be employed. More detailed description of the mobile application descriptor 76 will be provided herein in association with the following drawings. The dynamic mobile application base components 78 are operative in the suitable execution of the dynamic mobile application. The components 78 are generated dynamically by the application engine 73 in conjunction with the mobile application descriptor 76. The components 78 include application database structure definitions, user interface definitions, application logic routines, and the like. The synchronizer module 81 is operative in the synchronization of the application data between the mobile device 26 and the desktop device 28 of FIG. 2. The synchronizer module may also communicate with the server device 30 and is responsible for exchanging information with the server device 30.

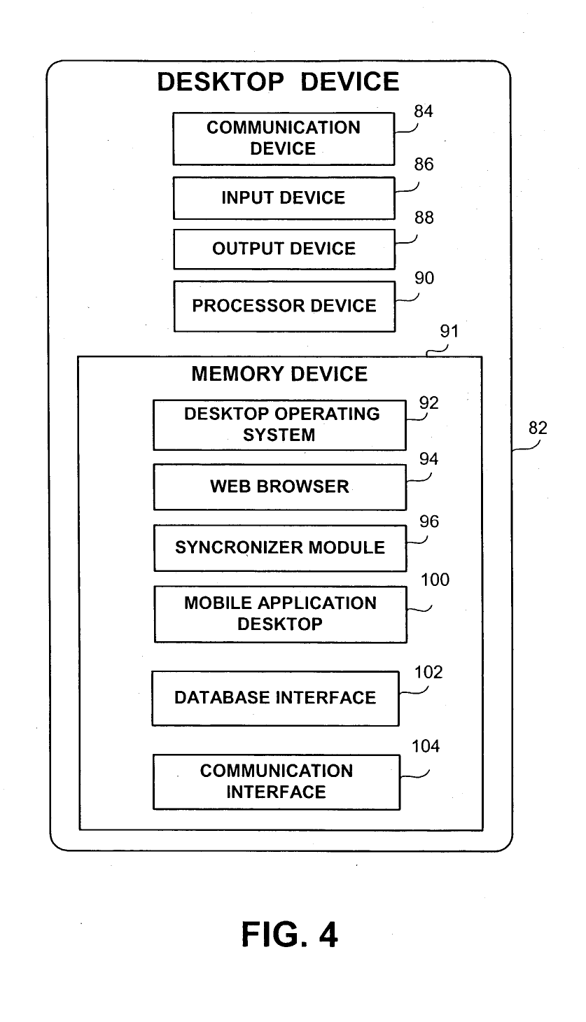

Referring now to FIG. 4 desktop device 82 includes a communication device 84, an input device 86, an output device 88, a processor device 90, and a memory device 91. Communication device 84 is a modem or a network interface card operative in the establishment of a communication link between the desktop device 82 and other remote platforms across the communication network. Input device 86 is utilized for providing interactive communication between the device 82 and a user. Input device 86 is typically a keyboard and a pointing device, such as a mouse. Output device 88 is typically a display screen to provide for the formatted display of information for the user. Processor device 90 is a logic circuitry that responds to and processes the basic instructions that drive a computing device. Memory device 91 is an electronic holding place for the instructions and data to be read from and write into by the processor device 66. Memory device 91 is preferably a high-capacity hard disk. Memory device 91 may store various operating systems and applications to be used in conjunction with the desktop device. The desktop operating system 92 is operative in the organization and control of the operations within the desktop device 82. Operating system 92 could the Windows 98, the Windows 2000, the Windows XP, and the like. Web browser 94 is a client application that provides interaction with content information in the network. The synchronizer module 96 is operative in the synchronization of the application data between the desktop device 82 and the mobile device 58 of FIG. 3. The database interface 102 is responsible for receiving and for organizing data sent from the legacy system 32 of FIG. 1. The communication interface 104 is operative in the establishment of connectivity between the desktop device 82 and other remote platforms across the network.

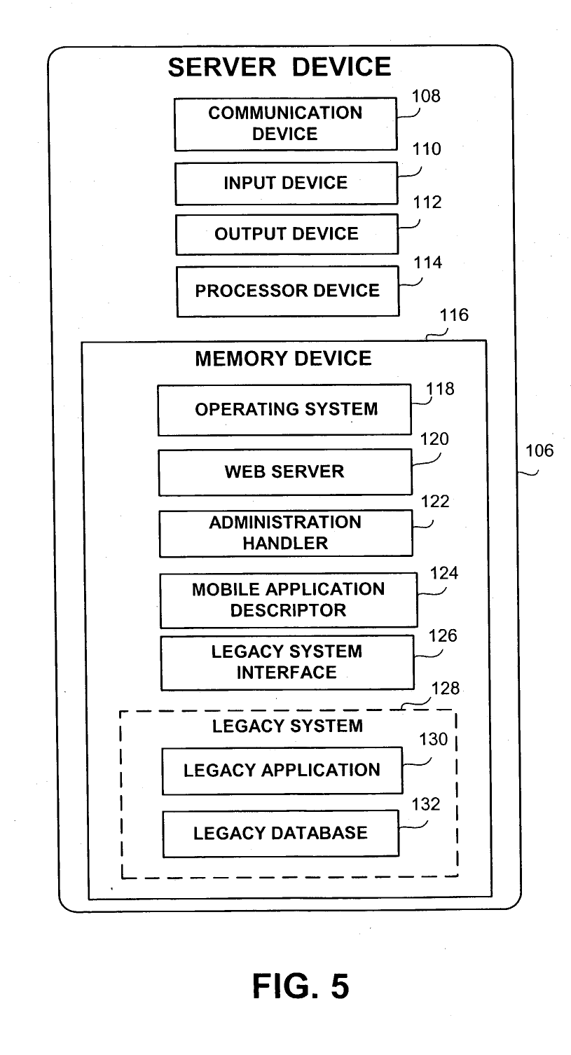

Referring now to FIG. 5 server device 106 includes a communication device 108, an input device 110, an output device 112, a processor device 114, and a memory device 116. It will be appreciated by persons skilled in the art that input and output devices 110, 112 are optional. Communication device 108 is a modem or a network interface card operative in the establishment of a communication link between the server device 106 and other remote platforms across the communication network. Input device 110 is utilized for providing interactive communication between the server device 106 and the operator of the device. Input device 106 is typically a keyboard, and a pointing device, such as a mouse. Output device 112 is typically a display screen to provide for the formatted display of information for the operator. Processor device 114 is a logic circuitry that responds to and processes the basic instructions that drive a computing device. Memory device 116 is an electronic holding place for the instructions and data to be read from and write into by the processor device 114. Memory device 116 is preferably a high-capacity hard disk. Memory device 116 stores an operating system 118, a web server 120, an administration handler 122, a mobile application descriptor 124, a legacy system interface 126, and a legacy system 128. The operating system 118 is operative in the organization and control of the computing and connectivity operations within the server device 106. Operating system 92 could the Windows 98, the Windows 2000, the Windows XP, and the like. Web server 120 is a program that serves files requested by one or more requesting programs. Web server 120 could be any of the commercially available server programs, such as the Apache server, or the Internet Information Server (IIS). The mobile application descriptor 124 is a specifically configured XML-based data structure that is operative in the generation of a specific mobile client application. More detailed description of the mobile application descriptor 124 will be provided herein under in association with the following drawings. The legacy system interface 126 is responsible for accessing the legacy system 128 and for interchanging data with the database of the legacy system. The legacy system interface 126 could use specific middleware components based on ASP, CGI, SQL, and the like. The legacy system interface 126 may be located remotely to legacy system 128. In one example, the legacy system interface 126 may be located on a remote server. The legacy system 128 includes a legacy application 130, and an associated legacy database 132. Note should be taken that the legacy system 128 and the associated legacy database 132 could be installed and executed externally to the server device 106. Thus, the legacy system 128 could operate independently on one or more separate computing platforms. Thus, the mobile application descriptor 124 could be provided to the mobile device from the server device 106, while the legacy system-specific application data could be provided to the mobile device from a separate computing platform.

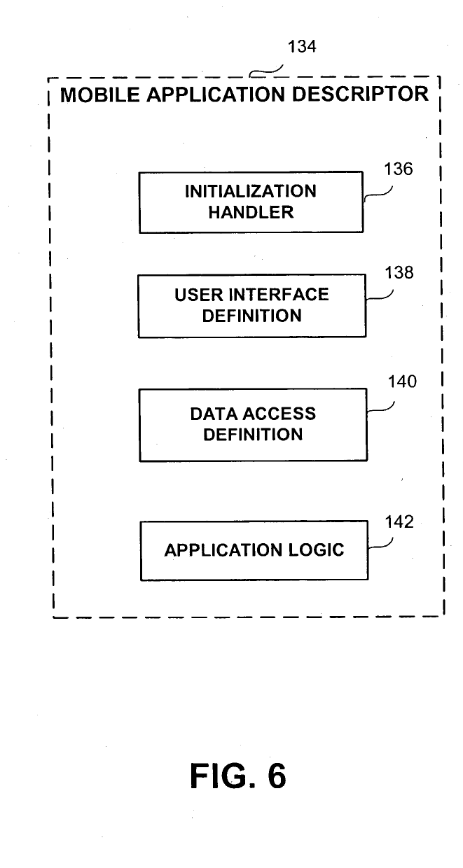

Referring now to FIG. 6 the mobile application descriptor 134 is a specifically configured XML-based data structure indicative of all the operative aspects of a mobile client application. A unique mobile application descriptor 134 is created for each unique mobile client application. The descriptor 134 could be periodically updated in accordance with the operative requirements of the system. Following the suitable updating process the descriptor 134 is preferably downloaded to the mobile device in order to effect the generation of an upgraded set of dynamic mobile application base components. The components would effect the re-programming and re-deployment of the dynamic mobile application. The mobile application descriptor 134 includes an initialization component 136, a user interface definition segment 138, a data access definition segment 140, and an application logic segment 142. The user interface definition segment 138 defines the architecture of the user interface, such as the structure of the output displays, and the like. The data access definition segment 140 is indicative of the structure of the application data, such as the location, and characteristics of the data fields constituting the application data. The application logic segment 142 includes application scripts that indicate the manner of the application execution. The application logic segment 192 includes workflow scripts to the order of events of the application, session scripts to define the structure of remote transactions, communication scripts, computational scripts, and the like. The initialization segment 136 is a script that provides for the running of the application script segment 142 and the other scripts 136, 138, 140, 142. Consequent to the design, development, and configuration of the mobile application descriptor 134 the descriptor is installed on the server device 106 of FIG. 5 in order to be downloaded by the mobile device 58 of FIG. 3. The mobile application descriptor 134 is operative in the generation of a set of dynamic mobile application base components on the mobile device 58 of FIG. 3. Note should be taken that the mobile application descriptor 134 is manually updateable in the server device. Thus, in accordance with the underlying concept of the invention, in order to deploy a new version of the mobile application the server-based mobile application descriptor 134 is modified and then downloaded to the client devices either in an automatic or semi-automatic manner.

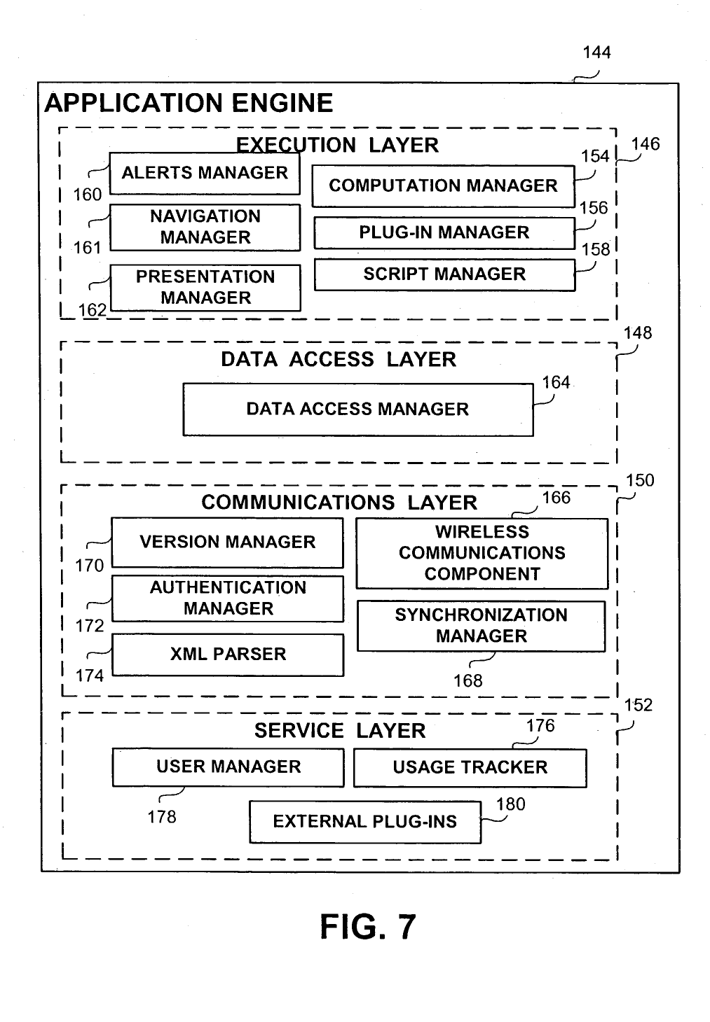

Referring now to FIG. 7, the application engine 144 is installed on the mobile device. The engine 144 includes an execution layer 146, a data access layer 148, a communications layer 150, and an optional service layer 152. The execution layer 146 is operative in the running of the user interaction processes and in the execution of the application logic. The execution layer 146 includes an alerts manager 160, a computation manager 154, a presentation manager 152, a plug-in manager 156, a script manager 158, and a navigation manager 161. Alerts manager 160 manages the alerts logic and the user interface. The presentation manager 162 handles the Graphical User Interface (GUI) elements and controls the data entry process. The navigation manager 161 manages the workflow by navigating in a suitable pre-defined manner between the application forms. The script manager 158 interprets and executes the embedded scripts used where the application logic has a high degree of complexity. The plug-in manager 156 handles installed plug-ins provided by external sources where the plug-ins that can be used to extend the capabilities of the system. The computation manager 154 handles the locally executed computation functions. The data access layer 148 includes the data access manager 164 that handles the access and maintenance of the application data including the data table structure, the data tables, indexing of the data, and the like. The communications layer 150 makes available the option for the client of the mobile device to connect to the server device either in a wireless manner or in a wired manner through the desktop device. The communications layer 150 includes a version manager 170, an optional authentication manager 172, an optional XML parser 174, a wireless communication component 166, and a synchronization manager 168. Version manager 170 is responsible for the handling of changes and modifications in the application interaction definitions. The optional authentication manager 172 is responsible for the sending of the data in a pre-defined authentication format, such as sending the user name and the password values in a specific format. XML parser 174 parses received application data and the mobile application descriptor. Wireless communications component 166 provides for wireless communication over a LAN, or a WAN. Synchronization manager 168 is responsible for the export and import of data between the mobile device and the back-end legacy system. Service layer 152 includes optional components within the mobile application. The layer 152 could include a user manager 178, a usage tracer 176, and one or more external plug-ins. Usage tracker 176 collects statistical data concerning the running of the application, such as which forms were accessed and how frequently were the forms accessed. User manager 176 manages single or multiple user access to the mobile application on a specific mobile device. External plug-ins 180 enhances the application by providing additional functions, such as barcode scanning, smart-card reading, medical instrument reading, and the like. The above described structure and constituent elements of the application engine are exemplary only. In other preferred embodiments of the present invention additional routines having enhanced functionality could be used, some or the routines could be combined while others could be dropped. The limits of the proposed system and method are delineated by the attached claims only.

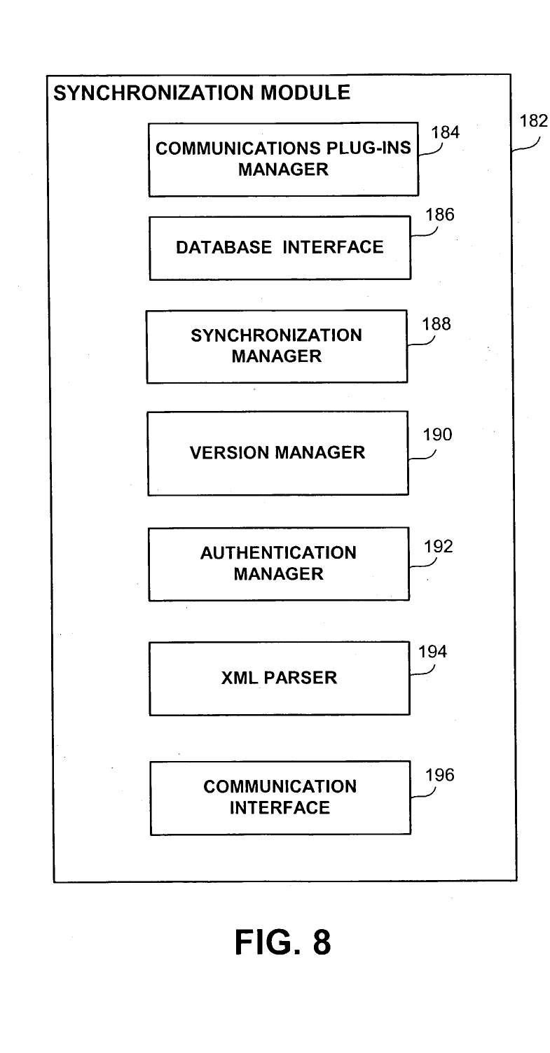

Referring now to FIG. 8 the synchronization module 182 is installed on the local desktop device 82 of FIG. 4. The principal functionality of module 182 is data synchronization with a database by direct access via, for example, SQL ODBC. The synchronization is accomplished by the synchronization manager 188. Optionally, module 182 could provide several additional functionalities. Thus, module 182 optionally includes a communications plug-ins manager 184, a database interface 186, a version manager 190, an optional authentication manager 192, an XML parser 194, and a communication interface 196. Communication plug-ins manager enables communication with APIs for data exchange. The APIs could provide access to the database of the legacy system or could perform operations on the data, such as data compression, and the like. Database interface 186 provides for a SQL ODBC direct access that enables creation of scripts during synchronization in order to read and write data from/to an SQL database. Version manager 190 is responsible for the handling of changes and modifications in the application interaction definitions. Authentication manager 192 is responsible for the sending of the data in a pre-defined authentication format, such as sending the user name and the password values in a specific format. XML parser 194 parses the received application data and the mobile application descriptor. In other preferred embodiments of the invention, yet additional routines could be utilized, such as for example, a generic synchronization engine to provide for uniquely customized synchronization between the desktop device and the mobile device. The generic synchronization engine will be preferably generate a unique synchronization procedure in accordance with parameters provided by a specific synchronization descriptor. In yet another preferred embodiments of the invention some of the above described routines could be combined or dropped altogether. The limits of the invention are delineated by the attached claims only.

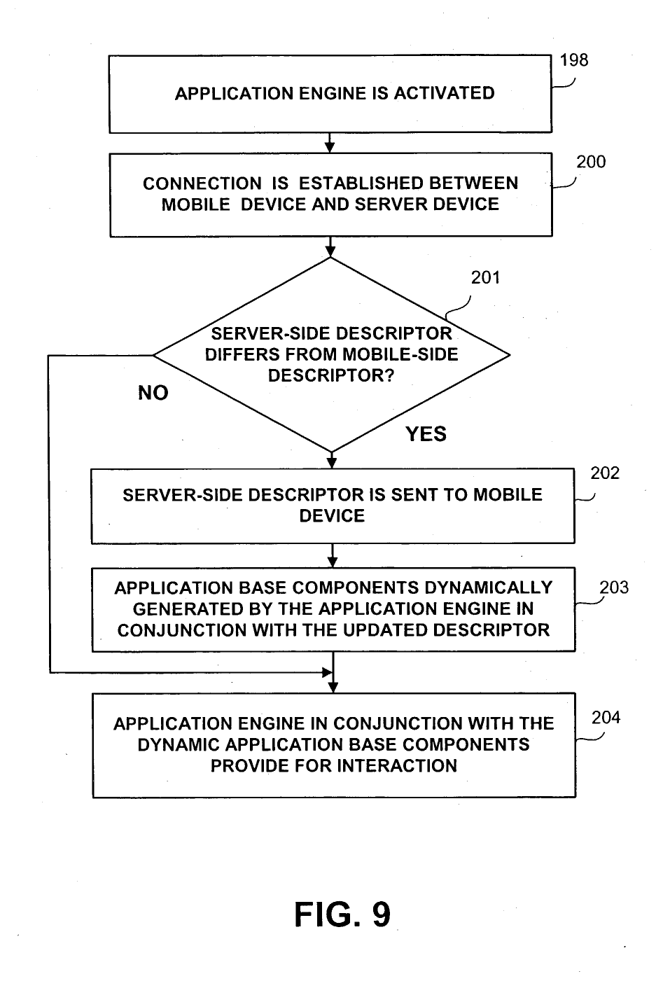

Referring now to FIG. 9 that illustrates the flow chart of the proposed method where the mobile device is directly connected to the server device. Such direct connection is typically accomplished by the establishment of a wireless link. At step 198 the application engine is activated in the mobile device to provide the option to the user of the mobile device to generate and deploy a dynamic mobile application or to re-program and re-deploy a dynamic mobile application. At step 200 a wireless connection is established between the mobile device and the server device via the data communication network. At step 201 it is determined whether the server-side mobile application descriptor is different from the mobile device-side mobile application descriptor. If the two descriptor files differ then at step 202 the server-side descriptor is downloaded to the mobile device and at step 203 the application engine in conjunction with the downloaded mobile application descriptor create or update a set of application base components operative in the execution of a dynamic mobile application. Consequently, at step 204, the application engine in conjunction with the dynamically created application base components provide the option to the user of the mobile device to run the dynamic mobile application through interaction with an application database.

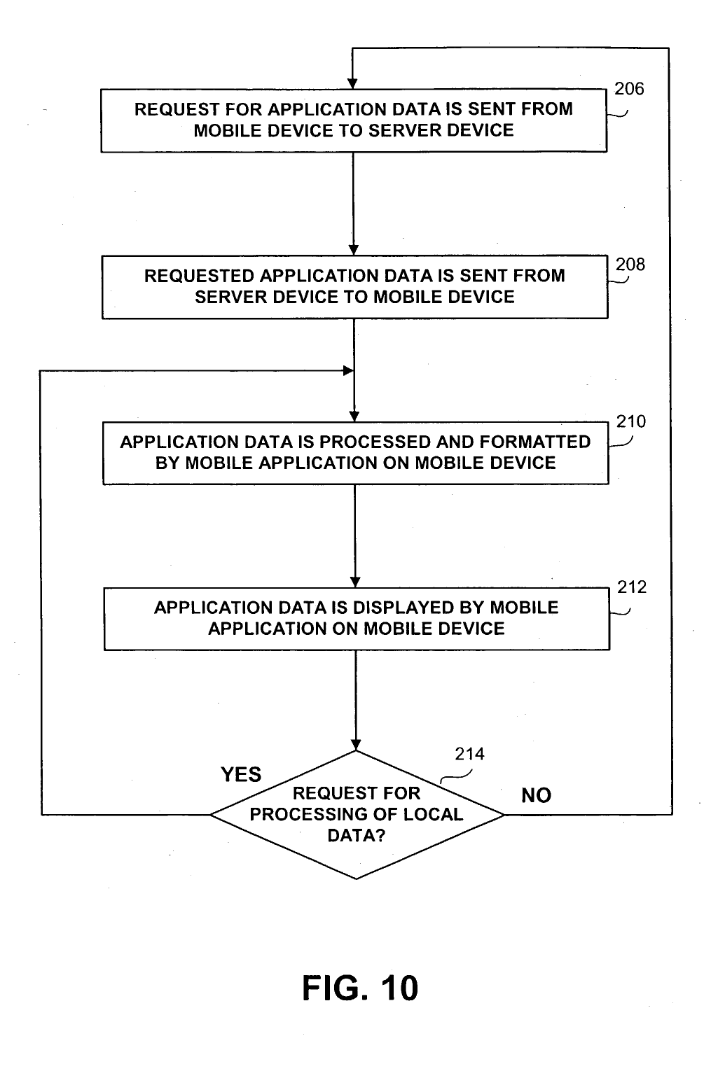

Referring now to FIG. 10 that describes a typical execution of a dynamic mobile application consequent to the deployment and generation of the dynamic mobile application. The application data provided by the legacy system could be accessed either locally or remotely. At step 206 consequent to a submittal of a request introduced by a user of the mobile device in respect of specific portions of the application data, the request for the desired data is sent to the server device. The web server installed on the server device responds to the request by activating the middleware components installed on the server device. The middleware components suitably interact with the legacy application and the associated legacy database. Consequently, the requested application data is obtained from the legacy database and the data is transmitted from the server device to the mobile device (step 208). At step 210 the application data is suitably formatted and processed by the application engine in conjunction with the set of the mobile application base components on the mobile device and at step 212 the processed and formatted application data is displayed for the user of the mobile device. At step 214 it is determined whether the user of the mobile device submitted a request for the processing of a locally available application data or a request for the processing of remotely located legacy data. Thus, as long as the processing of local data is required steps 210, 212, 214 will be executed locally in the mobile device. If a request for the processing of local data was submitted program control proceeds to step 210 to obtain the local data from a suitable caching area, to process the data suitably and to display the data to the user. If a request for the processing of the remotely stored application data was submitted then program control proceeds to step 206 to send the request to the server device. Note should be taken the above-described procedure provides the options for a user of the mobile device a) to process locally stored data where the need for remote data access is negated b) to obtain and process remotely stored data, and c) to obtain an updated mobile application descriptor and thereby generate and updated mobile application on the mobile device.

The proposed method could be performed in an alternative manner where the mobile device is connected to the server device via a desktop device. The desktop device is used as a communication channel between the server device and the mobile device. The desktop device is connected to the server device typically through the utilization of an either wired or wireless communication link via a data communications network, such as a LAN or a WAN. Requests for application data are submitted by a user operating the desktop device. The server responds to the requests by obtaining the requested application data from the legacy system and by transmitting the data to the desktop device. The mobile application synchronizes the application data in the desktop device with the application data on the mobile device. Consequent to the downloading of a new version of the mobile application descriptor from the server device to the desktop device and the resulting updating of the mobile application, the mobile application descriptor and the updated mobile application descriptor could be transmitted to the mobile device via the file synchronization process performed between the desktop device and the mobile device. Optionally the synchronization process between the desktop device and the mobile device could be controlled by a generic synchronization engine. The engine could operate in accordance with information embedded in a generic synchronization engine descriptor file.

Alternatively, the mobile device could obtain the application data directly from an independent legacy system platform by the establishment of a wireless link between the mobile device and the legacy system platform by the submittal of requests concerning the desired data by the appropriate routine of the application engine and by the insertion of the data into the suitable application database on the mobile device.

It will be appreciated by persons skilled in the art that the present invention is not limited to what has been particularly shown and described hereinabove. Rather the scope of the present invention is defined only by the claims, which follow.

I/we claim:

1. An apparatus for the generation and deployment of a an at least one mobile application associated with an at least one mobile device, the apparatus comprising the elements of:
an at least one application descriptor to store at least one application base component definition downloadable from an at least one server device to the at least one mobile device;
an at least one application base component in the at least one mobile device to control the execution of at least one mobile application; and
an at least one application engine in the at least one mobile device to obtain the at least one application descriptor, to generate the at least one application base component, to obtain application data, to provide access to application data, to manage communications, to manage data synchronization, and to manage the execution of at least one mobile application.

2. The apparatus of claim 1 further comprising a communications interface device in the at least one mobile device for establishing communication channels between the at least one mobile device and the at least one server device for downloading the at least one application descriptor from the at least one server device to the at least one mobile device.

3. The apparatus of claim 1 wherein the at least one application descriptor comprises the elements of:
an initialization handier to initialize the execution of an at least one application logic script;
an at least one user interface definition to hold an at least one parameter that defines the structure of an at least one user interface base component;
an at least one data access definition to hold an at least one parameter that defines the structure of an at least one data access definition base component.

4. The apparatus of claim 1 wherein the at least one application base component comprise a data access definition base component.

5. The apparatus of claim 4 wherein the at least one application base component is an application logic base component.

6. The apparatus of claim 5 wherein the at least one application base component is a user interface base component.

7. The apparatus of claim 1 wherein the at least one application engine comprises the elements of:
a presentation manager to process, format and display application data;
a script manager to manage the execution of the at least one application logic base component;
a data access manager to manage access to application data;
a computation manager to manage computations associated with the at least one application logic base component.

8. The apparatus of claim 7 further comprising a plug-in manager to manage
the execution of an at least one external plug-in module.

9. The apparatus of claim 7 further comprising an alerts manager to manage alerts logic.

10. The apparatus of claim 7 further comprising wireless communications manager to manage wireless communications between the at least one mobile device and the at least one server device.

11. The apparatus of claim 7 further comprising a synchronization manager to manage data synchronization between the at least one mobile device and the at least one server device.

12. The apparatus of claim 7 further comprising a version manager to provide for application base component version management.

13. The apparatus of claim 7 further comprising an authentication manager to provide user authentication.

14. The apparatus of claim 7 further comprising an XML parser to parse the at least one application descriptor file and at least application logic base component.

15. The apparatus of claim 7 further comprising a user manager to manage user access for at least one user of the at least one mobile device.

16. The apparatus of claim 7 further comprising a usage tracker to collect usage statistics.

17. The apparatus of claim 7 further comprising external plug-ins to provide for the installation, execution, and usage tracking of external plug-in routines.

18. The apparatus of claim 1 wherein the at least one mobile device is a hand held computing device having computing and data communications capabilities.

19. The apparatus of claim 18 wherein the at least one mobile device is a cellular phone having computing and data communications capabilities.

20. The apparatus of in claim 18 wherein the hand held computing device is a Personal Digital Assistant.

21. The apparatus of claim 1 wherein the at least server device is a computing platform giving computing and communication capabilities.

22. The apparatus of claim 1 wherein the at least one mobile device and the at least one server device communicate in a wireless manner via a data communications network.

23. The apparatus of claim 22 wherein the data communications network is a Local Area Network.

24. The apparatus of claim 23 wherein the data communications network is a Wide Area Network.

25. The apparatus of claim 24 wherein the data communications network is a cellular telephone communication network.

26. The apparatus of claim 1 wherein the at least one mobile device communicates with the at least one server device via an at least one desktop device.

27. The apparatus of claim 26 wherein the at least one desktop device is a computer device having computing, communications and data synchronization capabilities.

28. The apparatus of claim 1 further comprising an at least one legacy system to collect and transfer application data to the at least one mobile device in response to application data requests submitted by an at least one user of the at least one mobile device.

29. The apparatus of claim 28 wherein the at least one legacy system is implemented on an at least one independently operating computing and communicating platform.

30. The apparatus of claim 29 wherein the at least one computing and communicating platform transfers data to the at least one mobile device via the at least one server device.

31. A method for the generation and deployment of at least one mobile application associated with at least one mobile device, the method comprising the steps of:
transferring an at least one application descriptor file from an at least one server device to an at least one mobile device;
generating at least one application base component in accordance with the associated parameters in the at least one application descriptor file; and
generating a dynamic mobile application based on an at least one application engine and the at least one application base component.

32. The method of claim 31 further comprising activating the application engine installed in a mobile device.

33. The method of claim 31 further comprising establishing a communication path between the at least one mobile device and an at least one server device.

34. The method of claim 31 further comprising comparing the at least one application descriptor file in the at least one server device and the at least one application descriptor file in the at least one mobile device.

35. The method of claim 31 further comprising the step of submitting requests for application data to the at least one server device.

36. The method of claim 31 further comprising receiving application data transmitted from the at least one server device in the at least one mobile device.

37. The method of claim 31 further comprising sending the results of the user interactions on the application data to the at least one server device.
